(19) United States
(12) Patent Application Publication
(10) Pub. No.: US 2026/0250890 A1
(43) Pub. Date: Aug. 27, 2026

(54) WEBBING CONSTRUCTION FOR SAFETY HARNESSES

(71) Applicant: SAFEWAZE LLC, Concord, NC (US)

(72) Inventor: Cortland G. Schurian, Concord, NC (US)

(73) Assignee: SAFEWAZE LLC, Concord, NC (US)

(21) Appl. No.: 19/420,093

(22) Filed: Dec. 15, 2025

Related U.S. Application Data
(60) Provisional application No. 63/761,680, filed on Feb. 21, 2025.

(51) Int. Cl. D03D 13/00; A62B 35/00; D03D 9/00; D03D 15/283

(52) U.S. Cl. CPC D03D 13/004; A62B 35/0025; D03D 9/00; D03D 15/283; D10B 2321/0211; D10B 2401/063; D10B 2501/04

(57) ABSTRACT

A webbing construction for a safety harnesses is provided. The construction may include a first outer fabric portion, a second outer fabric portion, and an inner fabric portion positioned between the first and second outer fabric portion wherein the first and second outer fabric portions provides strength and the inner fabric portion provides breathability. The overall webbing construction will be regarded as acceptable for use by meeting or exceeding, for example, ANSI Standard Z359.11-2021 (FED-STD-191A/4108) while maintaining breathability and being comfortable.

### RELATED APPLICATION

The present application claims priority from U.S. Provisional No. 63/761,680 filed Feb. 22, 2025, the disclosures of which are incorporated herein by reference in their entireties.

### FIELD

The embodiments of the present invention relate to a web construction for safety harnesses wherein the construction provides the required strength while being breathable.

### BACKGROUND

Safety harnesses are often used in elevated environments to protect workers in the event of a fall. Typically, a fall protection harness includes straps that form the harness. These straps should meet government standards for strength and be abrasion resistance, namely after abrasion, the strength must be maintained. These straps when in position, however, may cause perspiration and irritation thus limiting the comfort to the protective harness wearer, in hot, humid and physically challenging environments. This is particularly important when the harness is worn for an extended time, and if not comfortable, the wearer will often use the harness incorrectly. Thus, there is a desire for a safety harness formed from a web construction that both meets industry standards and goals including strength, and is more breathable and comfortable to wear as compared to conventional harnesses.

### SUMMARY

A webbing construction for a safety harnesses is provided. The construction may include a first outer fabric portion, a second outer fabric portion, and an inner fabric portion positioned between the first and second outer fabric portion wherein the first and second outer fabric portions provides strength and the inner fabric portion provides breathability. The overall webbing construction will be regarded as acceptable for use by meeting or exceeding, for example, ANSI Standard Z359.11-2021 (FED-STD-191A/4108) while maintaining breathability and being comfortable.

### DESCRIPTION OF THE DRAWINGS

The embodiments are illustrated by way of example and not by limitation in the figures of the accompanying drawings and in which like reference numerals refer to similar elements and in which:

FIG. 1A illustrates a perspective view of one embodiment of the invention;

FIG. 1B illustrates a perspective view of the prior art;

FIG. 2 illustrates a perspective view of the invention; and,

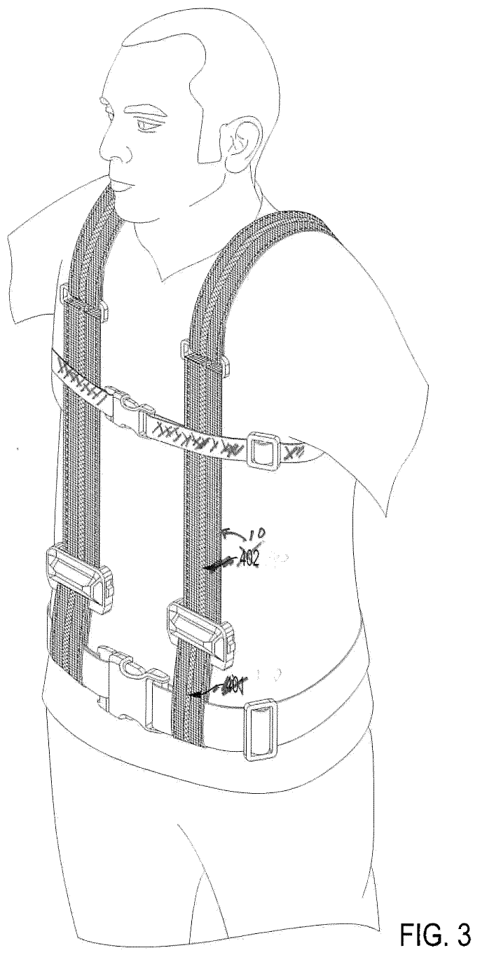

FIG. 3 illustrates a safety harness worn by a human figure and depicting an embodiment of the invention in use.

FIGS. 4 and 5 are another embodiment of the invention and depicts the front and back of the safety harness worn by a human figure.

### DETAILED DESCRIPTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

Although the present approach has been described herein with referenced to certain embodiments of the present invention, it is to be understood that the invention defined by the appended claims is not to be limited by details set forth in the above description as may perform similar functions and/or achieve like results. All such equivalent embodiments and examples are within the spirit and scope of the present approach.

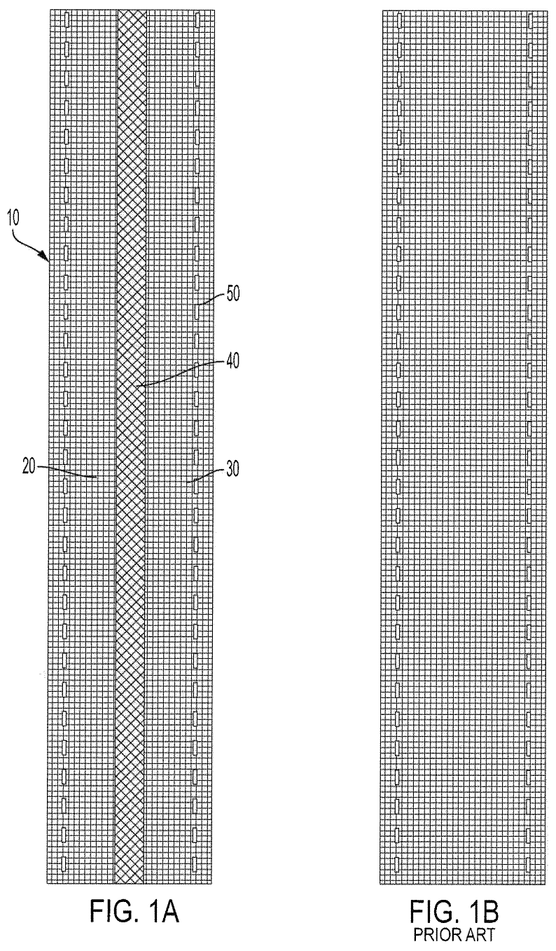

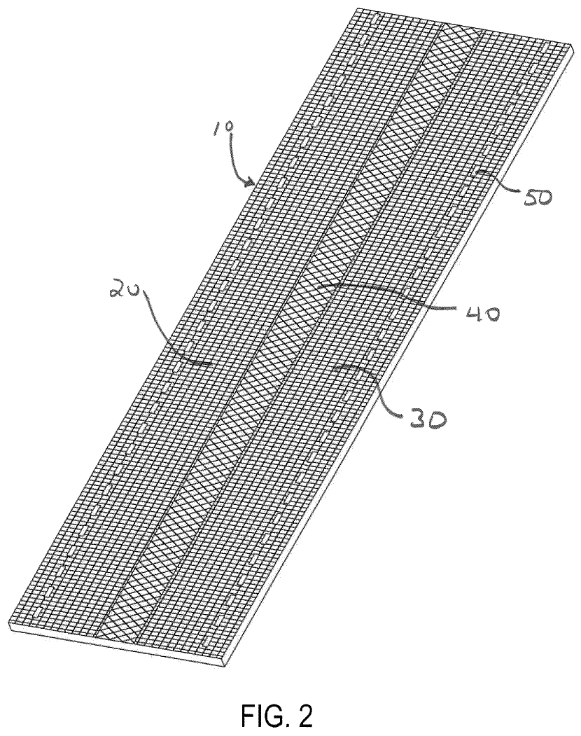

Referring to FIG. 1, a webbing construction 10 for a safety harness 100 is provided. The webbing construction may include a first outer fabric portion 20 and a second outer fabric portion 30. Positioned between the first and second outer portions 20, 30 may be a breathable inner fabric portion 40. The outer fabric portions 20, 30 provide significant strength so that a safety harness incorporating such webbing construction will meet ANSI Standard Z359.11-2021.

The fabric for the first outer fabric and the second outer fabric may be any fabric that provides significant strength to maintain and hold a person in place due to a fall or the like, and to meet or pass any strength test such as ANSI Standard Z359.11-2021. The fabrics may be of a wide variety of weave patterns including warp and weft yarns. The term “yarns” may include monofilaments, continuous fibers laid together and staple fibers twisted together. The yarns may be individual strands or multiple strands plied together. The warp and weft yarns may be woven to create a plain, twill or satin weave. The selection of specific fabrics will be within the skill of one in the art.

The actual yarns may be formed from a wide variety of natural or polymer fibers so long as the strength and abrasion resistance meet any standards. Exemplary polymers fibers may include ethyl vinyl acetate, polyethylene, polypropylene, nylon, rayon and aromatic polyesters fibers. These exemplary fibers are sold under the trademarks Spectra®, Cordura®, Dyneema®, Technora®, and Vectran®. fibers. The yarns may include other materials such as metal fibers, carbon fibers, and Kevlar®. One particularly desirable polymer fiber may be ultra-high molecular weight polyethylene (UHMWPE).

The fabric for the inner fabric portion (channel) may utilize the same yarns and polymer fibers as above or may be different. The inner channel 40 may be an open weave construction with a wide variety of weave patterns to provide breathability.

In another embodiment, the first outer fabric and the second outer fabric may be the fabric that provides breathability and the inner fabric portion may be any fabric that provides significant strength to maintain and hold a person in place due to a fall, and to meet or pass any strength test such as those based on ANSI Standard Z359.11-2021 (FED-STD-191A-4108).

In yet another embodiment, a first fabric portion may provide the breathability and a second fabric portion may provide the strength.

In any of the above embodiments it is noted that the fabric providing breathability may contribute to the strength of the overall webbing construction.

The safety harness may be assembled by using conventional weaving equipment. For example, a loom or the like may be set up to utilize the same yarns for the first portion, the second portion and the inner channel. In another embodiment, the first and second portion may be stitched together. The first outer fabric 20 and second outer fabric 30 may be woven into the center of the first and second outer fabrics 20, 30. In another embodiment, the first and second portion may be stitched together with the center portion positioned therebetween. The overall construction in addition to having strength and being breathable to meet the static and dynamic forces during use, should also be soft to conform to the wearer's body.

The first and second outer fabric portion 20, 30 and the breathable inner/channel portion 40 may have a thickness of 1 mm to 25 mm, and preferably may be 1 mm to 4 mm. The overall width of the webbing construction may be 1 mm to 300 mm with the outer fabric portions having a width of 5 mm to 50 mm and the inner fabric portion having a width of 5 mm to 50 mm. The outer fabric portions 20, 30 and the inner fabric portion may be of varying color. The outer fabric portions may also include a reflective element 50 such as silver or a fluorescent yarn/fiber for providing visual safety.

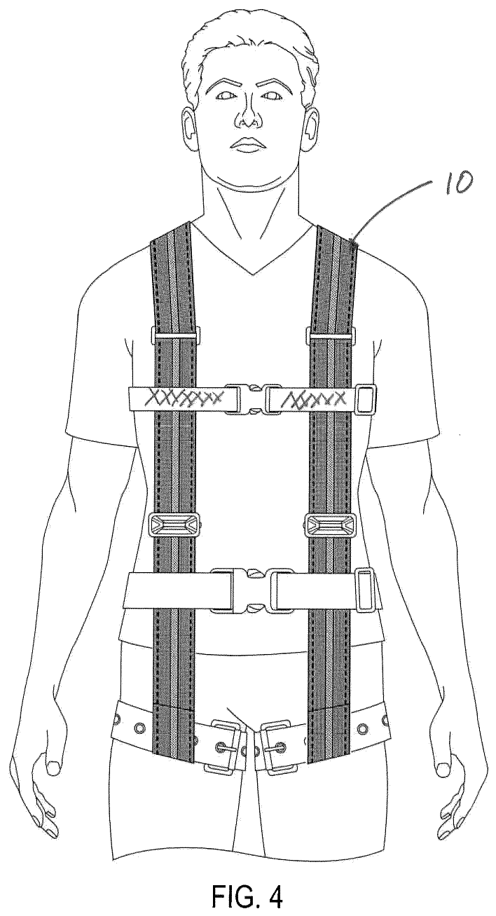

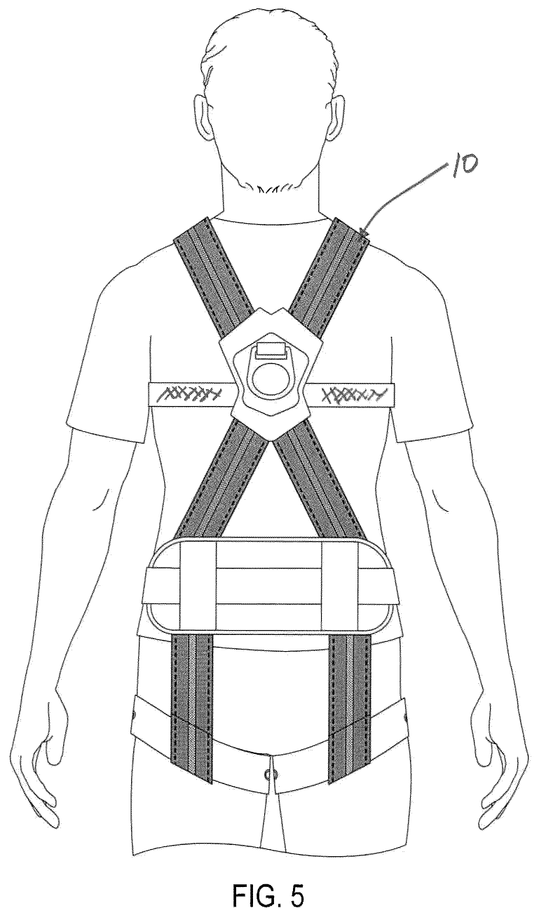

Referring to FIGS. 3-5, a safety harness 100 using the webbing construction is shown. It is noted that the breaking strength support belt 110 or the upper torso strap 120 may be formed from the webbing construction of the invention or may be of different construction. Also the webbing construction may be utilized in a safety harness including leg straps (not shown). The webbing construction may be used for a wide variety of end uses, the selection of which and the specific woven construction is within the skill of one in the art. Articles other than the safety harness illustrated using the webbing construction may include a support belt, torso strap, belt, leg straps, a strap for lifting heavy weights, backpack straps, seat belts, recreation and sporting equipment e.g., climbing straps, hunting harnesses, diving harnesses, and the like.

### EXAMPLE

A test piece of webbing construction is tested based on ANSI Standard Z359.11-2021 (FED-STD-191A-4108). The standard establishes the requirements for performance, particularly strength for full body harnesses such as those made using the webbing construction. In operation, the test piece is pulled at a rate of 75‡25 mm/min to break. The breaking strength was 33.24 kN. The breaking strength test passes.

An abraded piece of webbing construction was tested to ANSI Standard Z359.11-2021 (FED-STD-191A-4108) for Abrasion Resistance of Textile Webbing. A weight of 2.4 kg and a speed of 60 strokes/minutes for 5000 strokes abraded the webbing construction. The webbing strength should be not less than 16 kN. As tested, the breakage strength was 17.20 kN and thus passed.

Many modifications and other embodiments of the invention set forth herein will come to mind to one skilled in the art to which this invention pertains having the benefit of the teachings presented in the descriptions here. Therefore, it is to be understood that the invention is not to be limited to the specific embodiments disclosed and that modifications and other embodiments are intended to be included within the scope of the appended claims.

That which is claimed is:

1. A webbing construction for safety harnesses, the webbing construction comprising a first outer fabric portion and a second outer fabric portion and an inner fabric portion positioned between the first and second outer fabric portion wherein the first and second outer fabric portion provides strength and the inner fabric portion provides breathability, and the webbing construction meets or exceeds ANSI Standard Z359.11-2021 (FED-STD-191A-4108).

2. The webbing construction of claim 1, wherein the first outer fabric portion and the second outer fabric portion comprise ultra-high molecular weight polyethylene fibers.

3. The webbing construction of claim 1, wherein the inner fabric portion comprises ultra-high molecular weight polyethylene fibers.

4. A webbing construction for safety harnesses, the webbing construction comprising a first outer fabric portion and a second outer fabric portion and an inner fabric portion positioned between the first and second outer fabric portion wherein the first and second outer fabric portion provides breathability and the inner fabric portion provides strength, and the webbing construction meets or exceeds ANSI Standard Z359.11-2021 (FED-STD-191A-4108).

5. The webbing construction of claim 4, wherein the first outer fabric portion and the second outer fabric portion comprise ultra-high molecular weight polyethylene fibers.

6. The webbing construction of claim 5, wherein the inner fabric portion comprises ultra-high molecular weight polyethylene fibers.

7. A webbing construction for safety harnesses, the webbing construction comprising a strength fabric portion and a breathable fabric portion and the webbing construction based on meets or exceeds ANSI Standard Z359.11-2021 (FED-STD-191A-4108).

8. The webbing construction of claim 7, wherein the strength fabric portion and the second outer fabric portion comprise ultra-high molecular weight polyethylene fibers.

9. The webbing construction of claim 7, wherein the breathable fabric portion comprises ultra-high molecular weight polyethylene fibers.
